(19) United States
(12) Patent Application Publication
(10) Pub. No.: US 2018/0335503 A1
(43) Pub. Date: Nov. 22, 2018

(54) VEHICLE SYSTEM USING MEMS MICROPHONE MODULE

(71) Applicant: MAGNA ELECTRONICS INC., Auburn Hills, MI (US)

(72) Inventors: Heinz B. Seifert, Ortonville, MI (US); James Kane, Waterford, MI (US)

(21) Appl. No.: 15/983,204

(22) Filed: May 18, 2018

Related U.S. Application Data
(60) Provisional application No. 62/523,962, filed on Jun. 23, 2017.
(60) Provisional application No. 62/508,573, filed on May 19, 2017.

(51) Int. Cl. G01S 5/14; H04R 1/40; H04R 1/02; H04R 3/00; H04R 19/04; H04N 5/225; H04N 5/247; H04N 5/232; B60R 1/00; G01S 5/02

(52) U.S. Cl. CPC G01S 5/14; H04R 1/406; H04R 1/028; H04R 3/005; H04R 19/04; G06K 9/00791; H04N 5/247; H04N 5/23293; B60R 1/00; G01S 5/0221; H04R 2201/003; H04N 5/2253

(57) ABSTRACT

A sound classification system for a vehicle includes a plurality of microelectromechanical system (MEMS) microphones disposed at the equipped vehicle and sensing sounds emanating from exterior of the equipped vehicle. A sound processor is operable to process outputs of the MEMS microphones to classify a source of sensed sounds. The sound processor processes the outputs to determine the direction and distance of the source of the sensed sounds relative to the equipped vehicle. The MEMS microphones are one of (i) incorporated in respective ones of a plurality of exterior viewing cameras of the equipped vehicle and (ii) attached at a surface of at least one window of the equipped vehicle.

### CROSS REFERENCE TO RELATED APPLICATION

The present application claims the filing benefits of U.S. provisional applications, Ser. No. 62/523,962, filed Jun. 23, 2017, and Ser. No. 62/508,573, filed May 19, 2017, which are hereby incorporated herein by reference in their entireties.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties. Microphones are also known, such as microphones inside of a vehicle, such as described in U.S. Pat. Nos. 7,657,052 and 6,278,377, which are hereby incorporated herein by reference in their entireties.

### SUMMARY OF THE INVENTION

The present invention provides a driver or driving assistance system for a vehicle that utilizes one or more cameras to capture image data representative of images exterior of the vehicle, and provides a microelectromechanical systems microphone disposed at or incorporated in at least some of the exterior cameras. The cameras capture image data for a surround view or bird's-eye view display of the vehicle surroundings, and the microphones determine sounds at or near the vehicle. The system processes outputs of the microphones to determine sounds and to determine a location of the source of the sounds relative to the vehicle, such as an angle and/or distance of the source of the sounds relative to the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision/sound system that incorporates cameras and at least one MEMS microphone module in accordance with the present invention;

FIG. 2 is a plan view of another vehicle with a vision/sound system of the present invention;

FIG. 3 is a perspective view of a camera module with a microphone integrated therein; and

FIG. 4 is a block diagram showing the electrical architecture of the system of the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

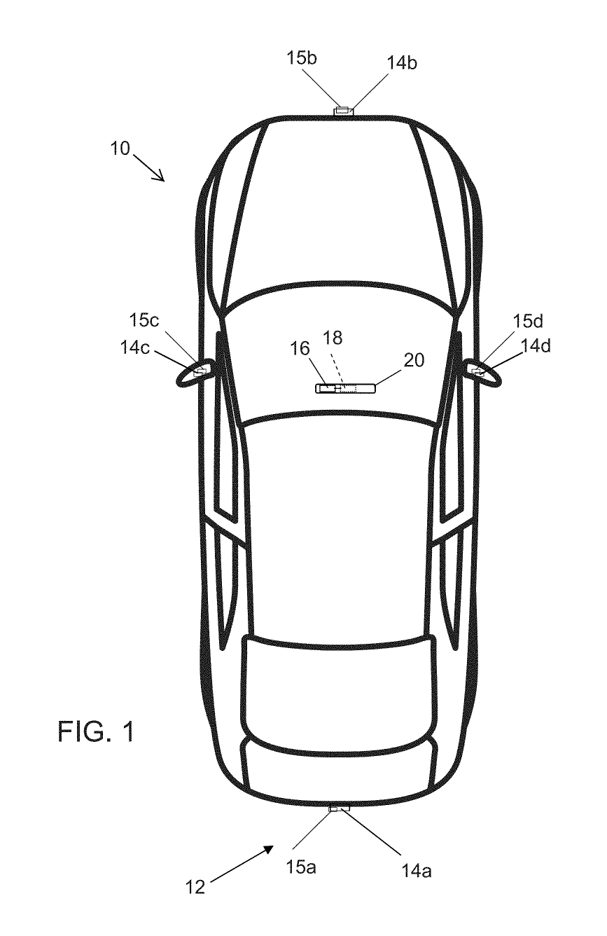

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens or lens assembly for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle. The surround vision cameras include a microelectromechanical systems (MEMS) microphone module 15a, 15b, 15c, 15d disposed at or incorporated in a respective one of the cameras 14a, 14b, 14c, 14d (shown in all of the camera 14a-d, but optionally disposed at or incorporated into only some of the exterior vehicle cameras), as discussed below.

It is desirable for vehicles to be able to acoustically sense their environment to emulate a sense that the human driver uses to navigate a vehicle through traffic. The vehicle system can then ‘listen’ to identify emergency vehicle sirens or other vehicles sounding their horn to warn of danger. The system may communicate acoustically with a pedestrian (the vehicle could stop at a pedestrian crossing, it could use a loudspeaker to tell the pedestrian that it will wait for the pedestrian and then process a verbal response from the pedestrian). The vehicle may be able to sense or determine the direction of the sound and may be able to determine how far away the source of the sound is from the vehicle.

Current vehicles do not have any microphones installed and cannot detect acoustic signals. It would be necessary to install at least three microphones at the vehicle to triangulate sound and it would be advantageous to have even more than three microphones. Preferably, the addition of microphones can still keep the wiring harness effort to a minimum. Also, the microphones need to be able to withstand the harsh environment and they would have to last for at least ten years and the solution would have to be extremely cost effective.

The system of the present invention provides the addition of a MEMS microphone to a vehicle surround view camera. Surround view systems utilize at least four and up to six (or more) cameras placed around the vehicle. The placement at different predefined locations at the vehicle allows the system to use the microphones to precisely triangulate sound sources. The microphone may send the digital signal through an amplifier directly into a microcontroller input where the pulse density signal is processed and then modulated on the regular camera data stream. The signal travels through the camera digital data medium (coaxial cable or automotive Ethernet) to a central ECU where the signals from all four to six microphones (with one such MEMS microphone at or incorporated in each of the four to six exterior cameras) are processed by a digital signal processor (DSP). The DSP performs the signal classification and may utilize triangulation to determine the signal direction and distance.

The DSP may be set up as a deep neural network to classify the signal (such as, for example, an emergency vehicle, horn, spoken words and/or the like). The type of signal, direction and distance may be provided as a vehicle network signal (e.g., CAN) and may then be used to trigger an action in the vehicle (such as, for example, to mute the infotainment system when an emergency vehicle is detected).

The MEMS microphone could either be disposed inside the camera enclosure acoustically coupled to the lens assembly of the camera or may be placed right next to the lens (such as at or near an outermost lens optic of the lens assembly) in order to interface to the outside of the vehicle in the same way the lens interfaces with the vehicle outside.

The application of MEMS (microelectromechanical systems) technology to microphones has led to the development of small microphones with very high performance. MEMS microphones offer high signal to noise ratios (SNR), low power consumption, good sensitivity, and are available in very small packages that are fully compatible with surface mount assembly processes. MEMS microphones exhibit almost no change in performance after reflow soldering and have excellent temperature characteristics.

MEMS microphones use acoustic sensors that are fabricated on semiconductor production lines using silicon wafers and highly automated processes. Layers of different materials are deposited on top of a silicon wafer and then the unwanted material is then etched away, creating a moveable membrane and a fixed backplate over a cavity in the base wafer. The sensor backplate is a stiff perforated structure that allows air to move easily through it, while the membrane is a thin solid structure that flexes in response to the change in air pressure caused by sound waves.

The application specific integrated circuit (ASIC) inside the MEMS microphone uses a charge pump to place a fixed charge on the microphone membrane. The ASIC then measures the voltage variations caused when the capacitance between the membrane and the fixed backplate changes due to the motion of the membrane in response to sound waves. Analog MEMS microphones produce an output voltage that is proportional to the instantaneous air pressure level. Analog microphones usually only have three pins: the output, the power supply voltage (VDD), and ground. Although the interface for analog MEMS microphones is conceptually simple, the analog signal requires careful design of the PCB and cables to avoid picking up noise between the microphone output and the input of the IC receiving the signal. In most applications, a low noise audio ADC is also needed to convert the output of analog microphones into digital format for processing and/or transmission.

As their name implies, digital MEMS microphones have digital outputs that switch between low and high logic levels. Most digital microphones use pulse density modulation (PDM), which produces a highly oversam pled single-bit data stream. The density of the pulses on the output of a microphone using pulse density modulation is proportional to the instantaneous air pressure level. Pulse density modulation is similar to the pulse width modulation (PWM) used in class D amplifiers. The difference is that pulse width modulation uses a constant time between pulses and encodes the signal in the pulse width, while pulse density modulation uses a constant pulse width and encodes the signal in the time between pulses.

The system of the present invention thus uses an MEMS microphone at or in or integrated with one or more (and preferably all) of the exterior cameras that capture image data for a surround view display derived from the captured image data. The MEMS microphone may be disposed inside the camera enclosure and acoustically coupled to the lens assembly or may be placed right next to the lens in order to interface to the outside of the vehicle in the same way the lens interfaces with the vehicle outside. The present invention thus includes cameras that capture image data for a surround view display system and that include microphones for sensing sounds at or near and exterior of the vehicle. By processing the sound signals from the multiple MEMS microphones, the system can classify the sound source and/or can determine the direction to the sound source and/or can determine the distance from the vehicle to the sound source.

Optionally, the system of the present invention may provide or comprise a small MEMS microphone module that is directly affixed to the glass (such as to an interior surface) of a vehicle window, such as a fixed or static window (windows that roll down would not be suitable). The system utilizes at least three and up to six (or more) microphone modules placed around the vehicle (such as at different windows of the vehicle). The placement at different predefined locations at the vehicle allows the system to use the microphones to precisely triangulate sound sources. The microphones send the digital signals through an amplifier directly into a microcontroller input where the pulse density signals are processed and then modulated on the vehicle network or a dedicated digital network. The signal travels to a central ECU where the signals from all three or four to six (or more) microphones are processed by a digital signal processor (DSP).

The DSP performs the signal classification and utilizes triangulation to determine the signal direction and distance. The DSP may be set up as a deep neural network to classify the signal (such as, for example, an emergency vehicle, horn, spoken words and/or the like). The type of signal, direction and distance may be provided as a vehicle network signal (e.g., CAN) and may then be used to trigger an action in the vehicle (such as, for example, to mute the infotainment system when an emergency vehicle is detected). The MEMS microphone is preferably mounted inside the vehicle (such as at an interior surface of the respective window) and is thus protected from the environment and functions to sense the sound through the vehicle window glass.

The system thus detects the presence of an approaching emergency vehicle(s) with activate siren(s). These vehicles react differently than other vehicles (e.g., they may run red lights, may not observe stop signs, etc.). The system of the subject vehicle determines if the emergency vehicle is approaching from behind or from directly ahead or from either side of the equipped vehicle. The system will also inform the driver that an emergency vehicle is approaching. This feature can expand functionality to determine the direction the emergency vehicle is coming from.

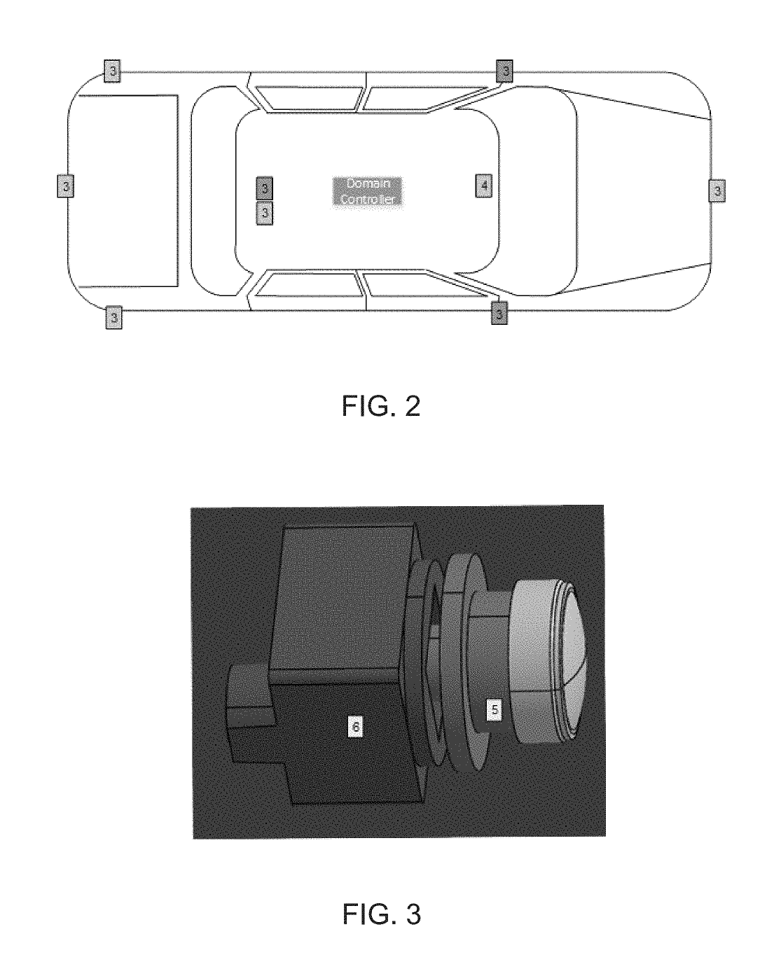

The MEM microphone may be disposed in a camera and can interface with the camera electronics (at a different carrier frequency). As shown in FIGS. 2 and 3, the vehicle may include multiple external cameras with microphones 3 and may include one or more internal cabin cameras with microphone 4. As shown in FIG. 3, the external camera includes the MEM microphone 5 and camera circuitry (disposed in the camera housing 6) that filters, digitizes and transmits audio data (along with image data captured by an imager and lens of the camera). The domain controller interface may comprise an LVDS interface, and may filter and digitize audio signals and transmit on existing LVDS pairs or on additional LVDS pairs. The microphone may comprise any suitable microphone, and may have an estimated maximum frequency at around 10 KHz.

The system may transmit digitized serial audio, and may transmit via I2S or PCM, connected to Back-Channel GPIOs of a UB953 and UB954 pair. The system may send GPIO from the camera to ECU side.

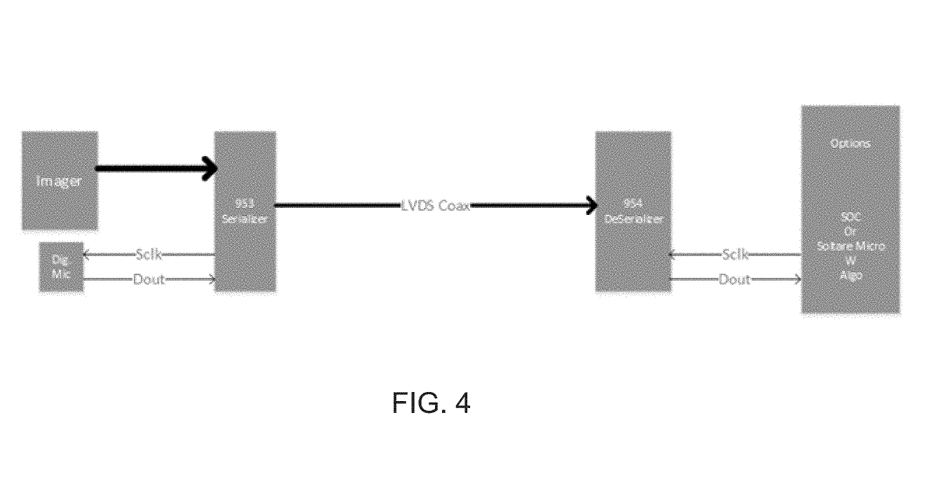

The microphone may be packaged in the camera, such as a 1 MPixel camera or a 2 MPixel camera or a 4 MPixel camera (or any number of mega pixels depending on the application). The electrical architecture may be implemented as shown in FIG. 4. As shown in FIG. 4, the imager and microphone are connected to a serializer (with the imager, microphone and serializer being part of the camera/microphone module at or near an exterior portion of the vehicle), which is connected (via an LVDS coaxial cable) to a deserializer and system on chip or microprocessor with the desired or appropriate algorithm (with the deserializer and SoC or microprocessor being located remote from the camera module, such as at a system control unit or the like).

The present invention provides the ability to mount a microphone in a camera and send audio data to an ECU. The system may determine siren signals and may distinguish sirens of emergency vehicles from other sounds or noises. The bandwidth of siren signals may be determined to accommodate or determine siren types globally. The system may also account for Doppler effects. The system may determine the Signal to Noise ratio of the siren signals in the environment the microphone is exposed to, including wind noise associated with the vehicle velocity, the location of the sensor(s), the noise associated with trains, community defense sirens (e.g., used to warn of upcoming or imminent tornadoes, monthly tests, etc.), jack hammers used during road and building construction, etc. The microphone may be mounted in a sealed camera package, and multiple camera/microphone units may be mounted at selected locations on the vehicle. The system thus may determine various noises exterior the vehicle (and direction and distance to the source of the noise(s)), and may generate an alert to an occupant or driver of the vehicle as to the type of noise detected and direction or location of the source of the noise. The alert may be provided as an audible alert or visual alert (such as an icon or message displayed at the display screen in the vehicle).

The system may include aspects of the sound systems described in U.S. Pat. Nos. 7,657,052 and 6,278,377 and/or U.S. Publication No. US-2016-0029111 and/or U.S. patent application Ser. No. 15/878,512, filed Jan. 24, 2018 (Attorney Docket MAG04 P-3250), which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A sound classification system for a vehicle, said sound classification system comprising:
a plurality of microelectromechanical system (MEMS) microphones disposed at a vehicle and sensing sounds emanating from exterior of the vehicle;
a sound processor operable to process outputs of said MEMS microphones;
wherein said sound processor is operable to process the outputs to classify a source of sensed sounds;
wherein said sound processor processes the outputs to determine the direction and distance of the source of the sensed sounds relative to the equipped vehicle; and
wherein said MEMS microphones are one of (i) incorporated in respective ones of a plurality of exterior viewing cameras of the vehicle and (ii) attached at a surface of at least one window of the vehicle.

2. The sound classification system of claim 1, wherein said MEMS microphones are incorporated in respective ones of a plurality of exterior viewing cameras of the vehicle.

3. The sound classification system of claim 2, wherein said exterior viewing cameras capture image data for a surround view display of the vehicle.

4. The sound classification system of claim 2, wherein said MEMS microphones and the respective exterior viewing cameras share common circuitry.

5. The sound classification system of claim 2, wherein each of said MEMS microphones is disposed inside a camera enclosure of the respective camera and acoustically coupled to a lens of the respective camera.

6. The sound classification system of claim 2, wherein each of said MEMS microphones is disposed inside a camera enclosure of the respective camera and disposed next to a lens of the respective camera.

7. The sound classification system of claim 1, wherein said MEMS microphones are attached at a surface of at least one window of the vehicle.

8. The sound classification system of claim 7, wherein said MEMS microphones are attached at an interior surface of at least one window of the vehicle.

9. The sound classification system of claim 7, wherein said MEMS microphones are attached at a surface of a respective one of a plurality of windows of the vehicle.

10. The sound classification system of claim 1, wherein said plurality of MEMS microphones comprises at least three MEMS microphones.

11. The sound classification system of claim 1, wherein said MEMS microphones are disposed at different predefined locations at the vehicle and wherein said sound processor utilizes triangulation to determine the direction and distance of the source of the sensed sounds relative to the equipped vehicle.

12. A sound classification system for a vehicle, said sound classification system comprising:
a plurality of cameras disposed at a vehicle so as to have respective exterior fields of view, said cameras capturing image data;
a plurality of microelectromechanical system (MEMS) microphones disposed at and incorporated in the respective cameras and sensing sounds emanating from exterior of the vehicle;
a sound processor operable to process outputs of said MEMS microphones;
wherein said sound processor is operable to process the outputs to classify a source of sensed sounds;
wherein said sound processor processes the outputs to determine the direction and distance of the source of the sensed sounds relative to the equipped vehicle; and
a display disposed in the vehicle so as to be viewable by an occupant of the vehicle, said display displaying video images derived from image data captured by said cameras.

13. The sound classification system of claim 12, wherein said display displays video images to provide a surround view to the occupant viewing said display.

14. The sound classification system of claim 12, wherein said MEMS microphones and the respective exterior viewing cameras share common circuitry.

15. The sound classification system of claim 12, wherein each of said MEMS microphones is disposed inside a camera enclosure of the respective camera and acoustically coupled to a lens of the respective camera.

16. The sound classification system of claim 12, wherein each of said MEMS microphones is disposed inside a camera enclosure of the respective camera and disposed next to a lens of the respective camera.

17. A sound classification system for a vehicle, said sound classification system comprising:
a plurality of cameras disposed at a vehicle so as to have respective exterior fields of view, said cameras capturing image data;
wherein said plurality of cameras include at least a rear camera disposed at a rear of the vehicle so as to have a field of view rearward of the vehicle, a driver-side camera disposed at a driver side of the vehicle so as to have a field of view sideward of the vehicle at the driver side of the vehicle, and a passenger-side camera disposed at a passenger side of the vehicle so as to have a field of view sideward of the vehicle at the passenger side of the vehicle;
a microelectromechanical system (MEMS) microphone disposed at and incorporated in each of said rear camera, said driver-side camera and said passenger-side camera, said MEMS microphones sensing sounds emanating from exterior of the vehicle;
wherein said MEMS microphones and the respective exterior viewing cameras share common circuitry;
a sound processor operable to process outputs of said MEMS microphones;
wherein said sound processor is operable to process the outputs to classify a source of sensed sounds; and
wherein said sound processor processes the outputs to determine the direction and distance of the source of the sensed sounds relative to the equipped vehicle.

18. The sound classification system of claim 17, wherein said sound processor utilizes triangulation to determine the direction and distance of the source of the sensed sounds relative to the equipped vehicle.

19. The sound classification system of claim 17, comprising a display disposed in the vehicle so as to be viewable by an occupant of the vehicle, said display displaying video images derived from image data captured by said cameras.

20. The sound classification system of claim 17, wherein each of said MEMS microphones is disposed inside a camera enclosure of the respective camera and one of (i) acoustically coupled to a lens of the respective camera and (ii) disposed next to a lens of the respective camera.
